(19) United States
(12) Patent Application Publication
(10) Pub. No.: US 2009/0271258 A1
(43) Pub. Date: Oct. 29, 2009

(54) METHOD FOR USING CARBON CREDITS WITH MICRO REFINERIES

(76) Inventor: Thomas J. Quinn, Los Gatos, CA (US)

Correspondence Address: DERGOSITS & NOAH LLP, Suite 1450, Four Embarcadero Center, San Francisco, CA, 94111, US

(21) Appl. No.: 12/110,242

(22) Filed: Apr. 25, 2008

(51) Int. Cl. G06Q 30/00

(52) U.S. Cl. 705/14

(57) ABSTRACT

A carbon credit coupon system is used to provide incentives to micro refinery operators to produce ethanol and reduce the CO₂ emissions by replacing gasoline with ethanol. The distribution of carbon credit coupon is based upon an accurate and quantifiable reduction in the emissions of CO₂ gas based upon the difference in emissions between gasoline and ethanol. The carbon credit coupons are distributed to micro refinery operators based upon the predicted or actual ethanol produced. The carbon credit coupons can be redeemed from vendors for good used to produce ethanol, corporate sponsors or entities in need of carbon credits in order to comply with government mandates to reduce carbon emissions, etc.

### FIELD OF INVENTION

The present invention relates generally to a method for using carbon credits to encourage the use of ethanol refinery system to convert sugar or discarded alcohol into ethanol.

### BACKGROUND

“Emissions trading” is an administrative approach used to control pollution by providing economic incentives for achieving reductions in the emissions of pollutants. It is sometimes called cap and trade. A central authority sets a limit or cap on the amount of a pollutant that can be emitted. Companies or other groups are issued emission permits and are required to hold an equivalent number of allowances or credits which represent the right to emit a specific amount of pollutants. The total amount of allowances and credits cannot exceed the cap, limiting total emissions to that level. Companies that need to increase their emissions must buy carbon credits from those who pollute less. The transfer of allowances is referred to as a trade. In effect, the buyer is paying a charge for polluting, while the seller is being rewarded for having reduced emissions by more than was needed.

Carbon credits are a component of national and international emissions trading schemes that have been implemented to mitigate global warming. Carbon credits provide a way to reduce greenhouse effect emissions on an industrial scale by capping total annual emissions and letting the market assign a monetary value to any shortfall through trading. Carbon credits can be exchanged between businesses or bought and sold in international markets at the prevailing market price. Companies, governments or other entities buy carbon offsets in order to comply with caps on the total amount of carbon dioxide they are allowed to emit.

Although there are several primary categories of greenhouse gases, carbon offsets are measured in metric tons of carbon dioxide-equivalent. One carbon offset represents the reduction of one metric ton of carbon dioxide, or its equivalent in other greenhouse gases. Correction factors that can be applied to other greenhouse gases. For example, methane gas has a global warming potential that is 23 times that of carbon dioxide. Thus, a metric ton of methane gas is equivalent to 23 metric tons of carbon dioxide.

A problem with carbon credits is quantifying the actual carbon dioxide reduction. Many programs are arbitrary in assigning a quantifiable reduction in carbon dioxide emissions. In order to encourage a reduction of green house gas emissions by individuals a consumer product is needed that allows individuals to directly reduce carbon dioxide emissions and a system is needed that provides incentives for using the product based upon easily quantifiable carbon dioxide emission reductions.

### SUMMARY OF THE INVENTION

The present invention is a method for using carbon credits with ethanol producing micro refineries. The micro refinery is a consumer product that converts sugar and feedstock and/or discarded alcoholic beverages into ethanol. A system of carbon credit coupons can be used to encourage the use of the micro refineries and the production of ethanol to reduce CO₂ emissions. The system provides carbon credit coupons to micro refinery operators based upon their production of ethanol.

The carbon credit coupons can have a value based upon the reduction of CO₂ emissions assuming that the ethanol produced by the micro refinery is used instead of the same or equivalent volume of gasoline. Since the emission of CO₂ from ethanol v. gasoline is directly quantifiable, the reduction in CO₂ emissions can be accurately determined for a volumetric measurement of ethanol.

The production of ethanol can be determined is several ways. When a micro refinery operator purchases sugar and feedstock for ethanol production, there is a relationship between the quantity of sugar purchased and the expected volume of ethanol that will be produced. In an embodiment, the carbon credit coupons are distributed when the sugar is purchased based upon the expected ethanol production. Different purities of sugar will have different ethanol yields, thus the distributed carbon credit coupons may correspond to the quantity and purity of the sugar purchased. In another embodiment, the distributed carbon credit coupons may correspond to measurement of the ethanol produced. The micro refinery may have an ethanol meter that detects the quantity of ethanol produced.

The carbon credit coupons can include: monetary value, corresponding CO₂ emission reduction weight, serial number, bar code or any other type of identification number that can be used to verify authenticity. The serial number can also be used to track and control the use of the coupon. The micro refinery can utilize the carbon credit coupons in various ways. In an embodiment, the coupons can only be used to purchase for materials used to make ethanol from an authorized materials supplier. Alternatively, the carbon credit coupons can be sold directly by the micro refineries to buyers or corporate sponsors.

Carbon credit buyers may be individuals or corporate entities that may wish to improve the world by reducing carbon footprints. The buys may also need to reduce carbon emissions in order to comply with the mandated government regulations limiting carbon emissions. The carbon credits can be sold to buyers in many different ways including direct sales. However, since the micro refineries may be remote from industrial buyers, it may be more practical to sell the carbon credits through a computer network or internet based sales system. The micro refinery may indicate the quantity of carbon credits available and sell one or all of the carbon credits at a specified price. Alternatively, the micro refinery may utilize an auction web site to auction some or all of the carbon credits to the highest bidder. In some cases a micro refinery may only have a small quantity of carbon credits and a number of micro refineries can combine and sell their cumulative carbon credits together.

It is also possible for the corporate entities to invest or sponsor the micro refineries and provide incentives such as purchasing all carbon credits or matching some of the carbon credit purchase price. The matching funds can be used to further expand the micro refinery program by providing additional materials for ethanol production or by purchasing additional micro refineries. The matching fund provider can benefit by promoting their company as an earth friendly company that is working to reduce carbon emissions. The inventive system can be used for various other corporate relationships.

### BRIED DESCRIPTION OF THE DRAWINGS

FIG. 1 illustrates a cross section of an embodiment of the micro refinery;

FIG. 2 illustrates an embodiment of a carbon credit coupon; and

FIG. 3 illustrates a communications network for an accounting system and micro refineries.

### DETAILED DESCRIPTION

The present invention is a method for using carbon credits with ethanol producing micro-refineries. The micro-refinery is a consumer product that converts sugar and feedstock and/or discarded alcoholic beverages into ethanol. The micro refineries are described in copending U.S. patent application Ser. No. 12/110,158, filed on Apr. 25, 2008, which is hereby incorporated by reference. The micro refineries can be purchased or leased from a manufacturer or distributor.

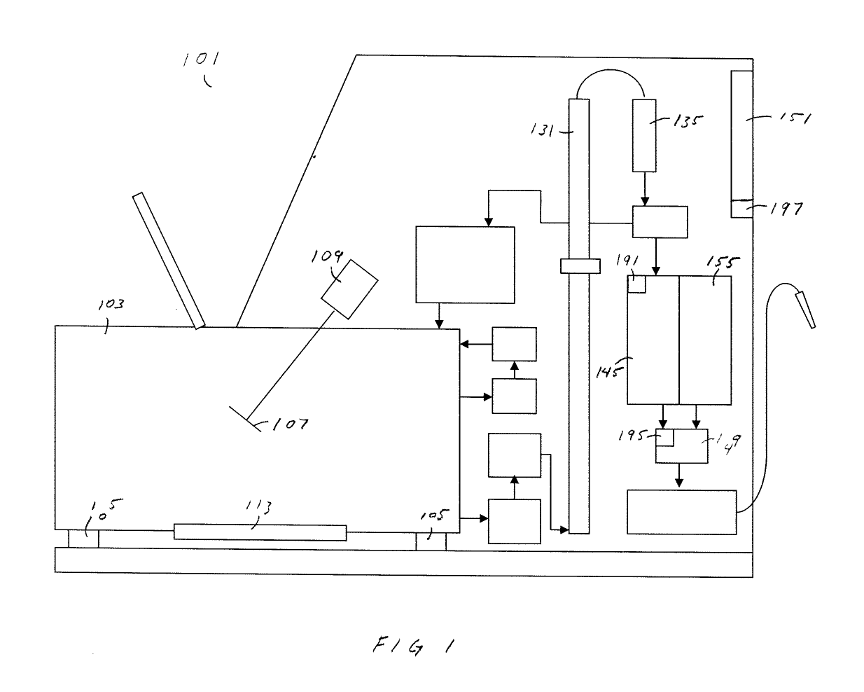

With reference to FIG. 1, in an embodiment the micro refinery 101 includes: a processing unit 151 having a user interface and a graphical display, a fermentation tank 103, a load cell weight detection system 105, a temperature control system 113 and a mixing agitator 107 coupled to a motor 109, a distillation system 131, a membrane separation system 135, an ethanol storage tank 145, a gasoline storage tank 155 and a blending and pumping system 149 that can all be mounted within a protective housing. The individual systems are coupled to the processing unit 151 which controls the operations of the micro refinery 101 and provides information and instructions to the user through the graphical display.

The micro refinery 101 converts sugar into ethanol in a controlled fermentation process that uses yeast and water in the fermentation tank 103. When fermentation is complete the micro refinery 101 uses the distillation system 131 to separate the ethanol from the water and other impurities. The vapors emitted from the distillation system 131 are then processed by a membrane separation system 135 to further purify the ethanol by removing the water and other impurities. The ethanol is stored in the ethanol storage tank 145.

In a different mode of operation, the micro refinery 101 can also be used to convert discarded alcoholic beverages into ethanol. The alcoholic beverages are placed in the fermentation tank 103 without any additional materials. The alcoholic beverages are fed directly to the distillation system 131 and then processed by the membrane separation system 135 to separate the ethanol from the water and other impurities. The ethanol produced in this mode of operation is also stored in the ethanol storage tank 145. It may also be possible to mix the alcoholic beverages into the fermentation tank 103 with the sugar processing described above after the fermentation process has been completed.

The controller 151 receives instructions from the user through an input device such as a keypad or other input devices. In an embodiment the controller 151 can be coupled to a computer network which may allow an accounting system to monitor the materials used, the ethanol produced and/or the ethanol pumped into vehicles by the micro refinery. The ethanol produced by the micro refinery 101 can be directly substituted for gasoline and can be used to power internal combustion vehicles. Since most vehicles cannot run on pure ethanol, the micro refinery 101 can blend the ethanol with gasoline at a ratio that is usable by the vehicle.

When a vehicle burns ethanol rather than gasoline, the CO₂ emitted is substantially reduced. The CO₂ emission reduction can be quantified by the difference in CO₂ emissions of gasoline which is not emitted minus the CO₂ emissions of ethanol. By knowing the volumetric different in CO₂ emissions, the total emissions reduction can be calculated by multiplying the volumetric different in CO₂ emissions by the quantity of ethanol produced and substituted for gasoline.

In an embodiment, the carbon credit coupon trades occur between a company or other entity and network of ethanol micro-refinery owners and operators. The micro refineries produce ethanol carbon and can obtain carbon credit coupons based upon a volume of ethanol that they produce. The distribution of carbon credits based upon the volume of ethanol produced accounts for both sugar and alcoholic beverage processing. Alternatively, the micro refineries can obtain carbon credit coupons based upon an expected reduction in CO₂ emissions for the quantity of ethanol produced by the fermentation of a known quantity of sugar. Since this distribution is only based upon sugar, this method may not account for alternative modes of ethanol produced from alcoholic beverages.

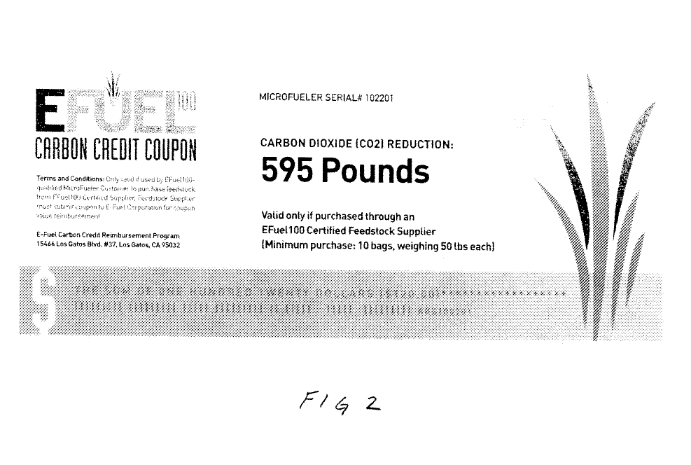

The carbon credit coupons are marked with a monetary value corresponding to a reduction in CO₂ emissions. With reference to FIG. 2, a carbon credit coupon can have a serial number and a monetary value corresponding to a reduction in CO₂ emissions resulting from the use of ethanol rather than gasoline. In this example, the monetary value is $120 which corresponds to a 595 pound reduction in CO₂ emissions or $0.20/pound reduction in CO₂ emissions. The relationship between the monetary value and the reduction in CO₂ emissions can be a variable exchange rate that is set by a company, an administrative agency, or governing body. The exchange rate can be based upon current environmental or market conditions or calculated from a combination of factors. For example, if environmental CO₂ levels increase, the monetary value of a reduction in emissions may also increase as the need for reductions in CO₂ becomes more urgent. Alternatively, if the CO₂ levels decrease, the value of reductions in CO₂ emissions may also decrease.

The carbon credit coupons may also have a restriction on use. In this example, the use of the carbon credit coupon is restricted to the purchase of feedstock used to produce ethanol. The feedstock must be purchased from an authorized materials distributor and the quantity of feedstock is at least ten fifty pound bags. In other embodiments, any other restrictions may be applied to the carbon credit coupons. For example, the subsidized assets from the carbon credit coupons may be restricted to use in a manner consistent with the environmental intent of the emissions reduction program. While controlled use of the carbon credit coupons is preferred, it is also possible that the carbon credit coupons may have a cash value without restrictions on use.

The carbon credit coupons can be distributed and redeemed in several different ways. In an embodiment, the coupons are distributed based upon the quantity and quality of the sugar purchased. By knowing the quantity and quality of sugar processed by a micro refinery, an expected volume of ethanol and an expected CO₂ emissions weight reduction can be determined. The micro refinery operator can purchase sugar and obtain carbon credit coupons corresponding to the expected CO₂ emissions reduction from the expected ethanol production.

In another embodiment, the carbon credit coupons are obtained by determining the quantity of ethanol produced by the micro refinery or the quantity of ethanol emitted by the micro refinery and used by a vehicle. With reference to FIG. 1, the micro refinery 101 may include a sensor 191 that detects the quantity of ethanol produced and a transmitter 197 that provides a communications means to a computer network such as the Internet. The micro refinery 101 may also include a sensor 195 that indicates how much ethanol has been pumped into a vehicle and meters or other mechanisms that indicate the cumulative volume of ethanol produced or pumped by the micro refinery 101.

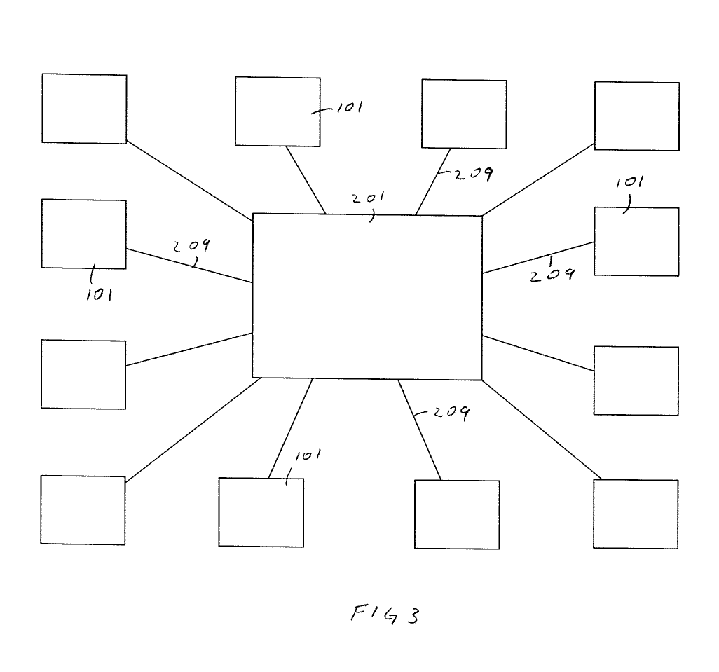

With reference to FIG. 3, an accounting system 201 can be in communication with many micro refineries 101. To obtain the carbon credit coupons, the micro refineries 101 can transmit new or cumulative ethanol production information based predicted ethanol production, actual ethanol production and/or ethanol distribution. In an embodiment, the micro refinery 101 sends ethanol production information and identification information to the accounting system 201. The communications connections 209 can be through the internet, computer network, telephone network, wireless network, etc.

If new ethanol production information is transmitted with identification information for each micro refinery, the accounting system may verify that the new ethanol production for each micro refinery has not been previously accounted for. The accounting system can then distribute the carbon credit coupons based upon the verified new ethanol production. If cumulative ethanol production information is transmitted with identification information for each micro refinery, the accounting system can subtract the prior cumulative ethanol production value to determine the new ethanol production for each micro refinery and then distribute the corresponding carbon credit coupons. The accounting system can keep records of all transactions and transmit the new carbon credit coupons electronically to the micro refinery operator through the computer network. Alternatively, the system can simply record the carbon credit coupons in electronic accounts that are accessible to the refinery operators.

In other embodiments, the ethanol micro refinery may not have electronic communications capabilities and the production of ethanol can be determined manually by reading an ethanol production meter. The micro refinery operator or a meter reader may obtain a reading of ethanol production directly from the micro refinery and transmit this information to the accounting system. The accounting system can then distribute the carbon credit coupons to the micro refinery operators.

After the carbon credit coupons have been distributed, the micro refinery operators can then use the coupons for various purposes. For example, paper carbon credit coupons may be redeemable in person through authorized or affiliated vendors. As discussed, the purchases may be restricted to the purchase of goods, such as feed stock or sugar used for ethanol production by the micro refineries. Alternatively, the coupons may be exchanged for a cash value or discounts on purchases. The entity receiving the carbon credit coupons may run a check of the serial number to confirm the validity of the coupon. The serial number may also be used to track and control the use of the funds.

It may also be possible to use carbon credit coupons to make purchases through a computer network such as a computer connected to the Internet. As discussed above, the carbon credit coupons each have a serial number. The buyer may input the serial number for a validation check prior to applying the value of the carbon credit coupons to the purchase. The micro refinery operators can then exchange the carbon credit coupons on a website to purchase goods such as sugar or feedstock used by the micro refinery to produce ethanol. The serial number may also be used to track and control purchases by the associated micro refinery. This method allows the entire carbon credit coupon system to be paperless. Thus, the carbon credit coupon system rewards micro refineries for helping to reduce CO₂ emissions.

A problem with some CO₂ emission reduction programs is that the actual CO₂ emission reduction may be arbitrarily determined. The present invention solves this problem by accurately quantifying the CO₂ emission reductions. If a gallon of ethanol produced by the micro refinery is used as a replacement fuel in a car, the reduced CO₂ emissions are easily quantifiable based upon the quantity of sugar used to produce the ethanol. The carbon credit coupon system places a “carbon reduction trade value” on all sugar or feedstock capable of making ethanol. The CO₂ emissions reduction of the sugar or feedstock is quantifiable based on a formula linked empirical to the reduction of CO₂ due to the micro refinery ethanol output. Thus, there is known relationship between a specific amount of feedstock and a reduction in CO₂ emissions such that a specific amount of sugar or feedstock having a known carbohydrate purity value produces a known quantity of ethanol. The volume of ethanol has a known CO₂ reduction value.

The calculations used to determine the CO₂ emission reduction are based upon a direct comparison of gasoline to ethanol. One gallon of gasoline burned in an internal combustion engine releases 8,877 grams of CO₂. In contrast, one gallon of ethanol burned in an internal combustion engine releases only 1,154 grams of CO₂. Thus, by using ethanol rather than gasoline, there is an 87% reduction in CO₂ emissions. For every gallon of gasoline that is replaced by a gallon of ethanol, 7,723 grams of CO₂ are not released into the atmosphere.

These figures can be used to determine the carbon savings over an extended period of time. In one year, a one micro refinery has the ability to produce 1,820 gallons of ethanol which is substituted for gasoline and results in a reduction of 14,055,860 grams or 1,896 lbs of CO₂ emissions. In order to produce 1,820 gallons of ethanol, about 25,480 pounds of feedstock and sugar is required. In this example, the sugar is extracted from dry crystal sugarcane that has a purity weighing 4 grams and provides 4 grams carbohydrate. The conversion rate for sugar having a purity weighing of 4 grams is about 0.0714 gallons of ethanol per pound of feedstock and sugar.

Since the conversion of the weight of sugar to a converted volume of ethanol is based upon the purity weighting of the sugar, other types of sugar have a different purity weights and will produce a different quantity of ethanol. That is, a type of sugar having a higher purity will provide more ethanol, while a sugar having a lower purity will produced less ethanol. In order to accurately predict the volume of ethanol produced from a weight of sugar, the purity of the sugar and the corresponding ethanol production rate for the sugar must be known.

A one year, 25,480 pound supply of sugarcane feedstock produces about 1,820 gallons of ethanol which may have an exchange trade value of $7,644 which is paid by the micro refinery operator for the feedstock. Thus, the exchange trade value of the sugarcane feedstock is about $0.30 per pound of sugarcane feedstock and when the feedstock cost is $4.20/gallon of ethanol. As discussed above, an operator of a micro refinery can offset these fuel production costs by applying the carbon credit coupons based upon the quantifiable reduction in CO₂ emissions. These figures and calculations are intended to be exemplary of how the inventive method may calculate the values of exchange trade value rather than actual values. As discussed above, the carbon credit exchanged trade value can be set by a regulator agency and may be variable based upon regional environmental conditions.

The inventive system may also incorporate corporate sponsorship. In an embodiment, a corporate sponsor of the program may be interested in promoting the production of ethanol by providing a redemption system for the carbon credit coupons. The users can go to the corporate sponsor and redeem the carbon credit coupons for cash, supplies or merchandise. The corporate sponsor can accumulate the carbon credit coupons and advertise the fact that it has reduced or even negative CO₂ emissions based upon the carbon credit coupons.

In other embodiments, a corporation may sponsor sales through an Internet based trading system or an auction web site used to sell the carbon credit coupons. The corporate sponsor can post advertising while the auction information is displayed on the web site. Companies in need of carbon credits can then purchase the carbon credit coupons through the web site. If a micro refinery only has a small number of carbon credit coupons, the website may facilitate the combining of carbon credit coupons and the proportional distribution of the cumulative purchase price.

The corporate sponsor may also provide financial support by providing matching of at least a portion of the purchase prices for the carbon credit coupons. For example, in order to encourage or enhance the auction prices for the carbon credit coupons, a corporate sponsor may match at least a portion of the purchase price with a donation to an organization, such as a charity, environmental organization, political organization, watchdog organization, etc. in order to promote a clean environment. Again, the corporate sponsor can provide advertisements regarding this sponsorship of the carbon credit coupon program. If the corporate sponsor does not require the carbon credits, it may also be able to sell these to other entities that are in need of carbon credits in order to comply with government mandates to reduce carbon emissions.

While the invention has been described herein with reference to certain preferred embodiments, these embodiments have been presented by way of example only, and not to limit the scope of the invention. Accordingly, the scope of the invention should be defined only in accordance with the claims that follow.

What is claimed is:

1. A method for providing incentives for ethanol production comprising:
(a) producing ethanol with micro refineries;
(b) calculating a value for a quantity of reduced CO₂ emissions for a volumetric quantity of the ethanol; and
(c) providing one or more carbon credits to each of the micro refineries, wherein a cumulative value of the one or more carbon credits provided to each of the micro refineries corresponds to the value of the reduced CO₂ emissions based upon a volume of ethanol produced by each of the micro refineries.

2. The method of claim 1, further comprising:
transferring the carbon credits to a materials distributor in exchange for goods or a discount on the goods purchased from the materials distributor;
wherein the goods purchased by the micro refinery include at least one of: sugar, yeast and yeast nutrients used by the micro refineries to produce the ethanol.

3. The method of claim 1, further comprising: selling the carbon credits to an entity in need of the carbon credits in order to comply with government mandates to reduce carbon emissions.

4. The method of claim 1, further comprising:
selling the carbon credits to an entity that wishes to subsidize the micro refineries and promote a clean environment.

5. The method of claim 1, further comprising:
selling the carbon credits through an auction utilizing a computer network.

6. The method of claim 5, further comprising:
receiving electronic payment for the carbon credits through the computer network.

7. The method of claim 1, further comprising:
selling the carbon credit coupons is through an internet trading system.

8. The method of claim 1, further comprising:
selling the carbon credits utilizing a computer network; and
providing a donation that is proportional to a selling price of the carbon credits.

9. The method of claim 8, further comprising:
displaying advertising through the computer network for an entity that provides the donation.

10. The method of claim 8, wherein the donation is given to the micro refineries in the form of goods used to produce the ethanol.

11. A method for providing incentives for ethanol production comprising:
(a) providing micro refineries that produce ethanol, wherein each of the micro refineries purchases a quantity of sugar having a purity from a materials distributor; and
(b) providing one or more carbon credit coupons to each of the micro refineries, wherein a cumulative value of the carbon credit coupons provided to each of the micro refineries corresponds to the quantity and the purity of the sugar purchased by each of the micro refineries.

12. The method of claim 11, further comprising:
transferring the carbon credits to a materials distributor in exchange for goods or a discount on the goods purchased from the materials distributor;
wherein the goods purchased by the micro refinery include at least one of: sugar, yeast and yeast nutrients used by the micro-refineries to produce the ethanol.

13. The method of claim 11, further comprising: selling the carbon credits to an entity in need of the carbon credits in order to comply with government mandates to reduce carbon emissions.

14. The method of claim 11, further comprising:
selling the carbon credits to an entity that wishes to subsidize the micro refineries and promote a clean environment.

15. The method of claim 11, further comprising:
selling the carbon credits through an auction utilizing a computer network.

16. The method of claim 15, further comprising:
receiving electronic payment for the carbon credits through the computer network.

17. The method of claim 11, further comprising:
selling the carbon credit coupons is through an internet trading system.

18. The method of claim 11, further comprising:
selling the carbon credits utilizing a computer network; and
providing a donation that is proportional to a selling price of the carbon credits.

19. The method of claim 18, further comprising:
displaying advertising through the computer network for an entity that provides the donation.

20. The method of claim 18, wherein the donation is given to the micro refineries in the form of goods used to produce the ethanol.
